(19) United States
(12) Patent Application Publication
(10) Pub. No.: US 2009/0092875 A1
(43) Pub. Date: Apr. 9, 2009

(54) FUEL CELL, MEMBRANE ELECTRODE ASSEMBLY

(75) Inventors: Hideo Daimon, Ibaraki-shi (JP); Sun Shouheng, Providence, RI (US); Wang Chao, Providence, RI (US)

Correspondence Address: BIRCH STEWART KOLASCH & BIRCH, PO BOX 747, FALLS CHURCH, VA, 22040-0747, US

(73) Assignees: HITACHI MAXELL, LTD., Ibaraki-shi (JP); BROWN UNIVERSITY, Providence, RI (US)

(21) Appl. No.: 11/868,354

(22) Filed: Oct. 5, 2007

(51) Int. Cl. H01M 8/10; B01J 23/42; B01J 23/44; C01B 13/00

(52) U.S. Cl. 429/30; 423/579; 502/325; 502/339

(57) ABSTRACT

An acid resistant composite catalyst comprising dumbbell-shaped composite nanoparticles each comprising a noble metal nanoparticle epitaxially conjugated to a ferrite particle, and/or flower-shaped composite nanoparticles each comprising a noble metal nanoparticle epitaxially conjugated to at least two ferrite particles. The acid resistant composite catalyst is useful to facilitate the reduction of oxygen. The acid resistant composite catalyst can be used in a fuel cell comprising a fuel electrode, an oxygen electrode, and a polymer electrolyte membrane placed between the fuel electrode and the oxygen electrode. The oxygen electrode includes the acid resistant composite catalyst.

### BACKGROUND OF THE INVENTION

1. Field of the Invention

The present invention relates to fuel cells and membrane electrode assemblies. More specifically, the present invention relates to a fuel cell and a membrane electrode assembly comprising a catalyst for oxygen reduction reaction comprising an acid resistant composite catalyst particle comprising a noble metal nanoparticle epitaxially conjugated with at least one ferrite nanoparticle.

2. Description of Related Art

For the most part, electric energy has been supplied by thermal power generation, water power generation, and nuclear electric power generation. However, the thermal power generation burns fossil fuels such as oil and coal and it causes not only extensive environmental pollution, but also depletion of resources, such as oil. The water power generation requires large scale dam construction and it causes destruction of nature and there is the problem that the dams have limited locations where they can properly be constructed. Further, the nuclear electric power generation has problems such as radioactive contamination in the event of an accident which can be fatal, and the decommissioning of a nuclear reactor facility is difficult. As such, nuclear reactor construction is decreasing on a global basis.

As a power generation system which does not require large scale facilities nor causes environmental pollution, wind power generation and solar photovoltaic power generation have come into use around the world. It is true that wind power generation and solar photovoltaic power generation have been put to practical use in some places. However, wind power generation cannot generate power without wind and the solar photovoltaic power generation cannot generate power without sunlight. The two systems are dependent on natural phenomena, and thus, are incapable of producing a stable power supply.

Recently, a power plant that draws electric energy out of hydrogen energy, such as hydrogen fuel cells, has been under active development. The hydrogen is obtained by reforming hydrocarbons which exist inexhaustibly on the earth. In addition, hydrogen has a large chemical energy per unit mass, and it does not generate a hazardous substance or global warming gas when used as an energy source.

A fuel cell which uses methanol, instead of hydrogen, has also been studied actively. A direct methanol fuel cell (DMFC) that directly uses methanol, which is a liquid fuel, is easy to handle, transport and store. Thus, the DMFC is, expected to be used as a power source for mobile electronic devices. A theoretical output voltage of the DMFC is 1.2 V (at 298 K), which is almost the same as that of the hydrogen fuel cell. Thus, they have the same characteristics in principle.

In the center of polymer electrolyte fuel cell (PEFC) and DMFC, there is proton conductive polymer membrane. An anode catalyst layer is coated on one side of the membrane and a cathode layer is coated on the other side. In PEFC and DMFC, hydrogen and methanol are supplied to the anode, respectively. On the other hand, oxygen is supplied to cathode in each fuel cell. Generally, PtRu is used for the anode catalyst and Pt is used for the cathode catalyst in PEFC and DMFC.

In DMFC, methanol is ultimately oxidized to carbon dioxide (CO₂) on the Pt anode catalyst. In the oxidation reaction, carbon monoxide (CO) is generated during the oxidation reaction. CO strongly chemisorbs on the Pt catalyst surface, thus the CO is a poison for the Pt catalyst. In the case where Pt is used for anode catalyst alone, the surface of the Pt catalyst is gradually covered with CO, and finally its catalytic activity is lost. Intensive research has been conducted on the CO poisoning problem. It was found that the addition of Ru is effective to reduce the CO poisoning. The mechanism involving the suppression of CO poisoning by addition of Ru is as follows.

CH₃OH+Pt═Pt—CO+4H⁺+4e⁻ (1)

Ru+H₂O═Ru—OH+H⁺+e⁻ (2)

Pt—CO+Ru—OH═Pt+Ru+CO₂+H⁺+e⁻ (3)

According to chemical reaction (1), CO generates during the oxidation reaction of methanol and it strongly chemisorbs on the surface of the Pt catalyst. This is the CO poisoning. On the other hand, water chemisorbs on Ru and the hydroxyl functional group is generated according to chemical reaction (2). This hydroxyl functional group that chemically bonds to Ru attacks CO chemisorbed on the Pt surface and oxidizes it to CO₂ according chemical reaction (3).

Ru itself has no catalytic activity for methanol oxidation and it is an assistant catalyst that suppresses CO poisoning of Pt catalyst. According to the mechanism mentioned above, it is an ideal state that Pt and Ru atoms exist in close vicinity to each other. In PEFC, there is a trace of CO existing in the hydrogen gas supplied to the anode. In the case of a Pt anode catalyst, the catalytic activity for hydrogen oxidation is also deactivated by chemisorption of CO on the Pt surface. The addition of Ru into a Pt catalyst also suppresses the CO poisoning in PEFC.

The activation energy of the oxygen reduction reaction on the Pt cathode catalyst is much larger than that of hydrogen oxidation reaction on PtRu anode catalyst. Thus, in PEFC, the amount of Pt cathode catalyst utilized is larger than that of PtRu anode catalyst. Pt catalyst used in the fuel cell is quite an expensive noble metal. Pt catalysts used in the fuel cells are prepared in a reduction reaction of Pt compounds that contain Pt in an oxidized state. The lowest priced precursor of Pt is hydrogen hexachloroplatinate (IV) hexahydrate which was recently priced as high as ¥2,900/g (reagent grade). From this price, material costs for preparing 1 g of metal Pt is calculated to be ¥7,700. In PEFC, the loading amount of Pt catalyst in the anode and cathode is about 0.5 mg/cm² to give an ordinal power density of PEFC of 175 mW/cm² at cell voltage of 0.4 V. Thus, for example, 5.7 g of metal Pt is required for 1 kW level co-generation system, which means that ¥44,000 is required for the material cost of Pt in the system. Therefore, it Is necessary to reduce the cost of fuel cell by minimizing the amount of expensive Pt catalyst utilized.

### SUMMARY OF THE INVENTION

In view of the foregoing, it is an object of the present invention to provide highly active catalysts for oxygen reduction and to reduce the cost of the catalyst for the fuel cells.

To these ends, according to a first aspect of the present invention, there is provided a fuel cell that comprises a fuel electrode, an oxygen electrode, and a polymer electrolyte membrane placed between the fuel electrode and the oxygen electrode, wherein a catalyst for oxygen reduction in the oxygen electrode assembly comprises an acid resistant composite catalyst particle comprising a noble metal nanoparticle epitaxially conjugated with at least one ferrite nanoparticle.

According to a second aspect of the present invention, there is provided a membrane electrode assembly that comprises a fuel electrode catalyst layer, an oxygen electrode catalyst layer, and a polymer electrolyte membrane placed between the fuel electrode catalyst layer and the oxygen electrode catalyst layer, wherein the oxygen electrode catalyst layer includes a composite catalyst assembly comprising a catalyst for oxygen reduction reaction comprising an acid resistant composite catalyst particle comprising a noble metal nanoparticle epitaxially conjugated with at least one ferrite nanoparticle.

The present inventors have found that an acid resistant composite catalyst that is composed of a noble metal particle epitaxially conjugated to at least one ferrite particle improves the activity for oxygen reduction reaction. In the composite catalyst, the noble metal particle and the ferrite particle bond with a strong force. This strong force is supposed to cause changes in the electron state of the noble metal, which is considered to improve the activity for the oxygen reduction reaction.

Herein, the term “acid resistant” means that the composite catalyst will not dissolve when placed In an aqueous solution at a pH of 1 at room temperature for 24 hours.

Herein, the term “epitaxially conjugated” means that the ferrite particle(s) has(have) been epitaxially grown on the surface of the noble metal particles and there is a bond between the noble metal particle and the ferrite particle which is the result of this epitaxial growth mechanism.

Any known polymer electrolyte membrane can be used between the fuel electrode catalyst layer and the oxidation electrode catalyst layer of the fuel cell. Generally, Nafion® membrane, available from E.I. DuPont de Namours and Company, is used. The Nafion® membrane is perfluorosulfonic acid having a hydrogen atom of a sulfonic group which easily splits off as H⁺ due to the high electronegativity of fluorine, and as such, shows high proton conductivity. High proton conductivity means that the Nafion® membrane has a high acidity.

One way to enhance the oxygen reduction activity of a Pt catalyst is to add a transition metal such as Mo, Mn, Fe, Co and Ni. Also, to activate inert Au particles, one can support the Au particles with transition metal oxide particles such as FeO, α-Fe₂O₃, CoO and NiO However, these transition metals and transition metal oxides are not acid resistant. Therefore, if these transition metal and transition metal oxides come into contact with the strongly acidic Nafion® membrane, the transition metals and transition metal oxides are dissolved as transition metal ions. Once the ions are dissolved, H⁺ in the Nafion® membrane is exchanged with the dissolved transition 30 metal ions, which reduces the proton conductivity of the Nafion® membrane and deteriorates cell performance. However, since ferrite particles such as Fe₃O₄ has acid resistance, dissolution to acids hardly occurs, thus being suitable for use as a catalyst material for a fuel cell.

As part of the present invention is a process of making the composite nanoparticle catalyst, wherein the composite nanoparticle catalyst is composed of a noble metal particle and a metal oxide particle where the metal oxide particle is epitaxially grown on a surface of the noble metal particle, said process comprising: mixing an organic solvent and a surfactant, adding a metal oxide precursor, adding noble metal nanoparticles dispersed in an organic solvent as, seeds, heating the solution to reflux, and precipitating composite nanoparticles from the mixture.

Another aspect of the present invention is a process of making the acid resistant composite nanoparticle catalyst, wherein the composite nanoparticle catalyst is composed of a noble metal particle and a metal oxide particle where the metal oxide particle is epitaxially grown on a surface of a noble metal particle, said process comprising: mixing an organic solvent with a surfactant and a reducing agent, adding a metal oxide precursor, adding a noble metal precursor, heating said mixture to reflux, and precipitating composite nanoparticles from the mixture.

The present invention is also drawn to a process of preparing a noble metal nanoparticle with controlled shape (FIG. 1A and 1B). Said process comprising: mixing an organic solvent with a surfactant, adding noble metal precursor to the mixture, and precipitating nanoparticles from said mixture.

The anode catalyst used in PEFC and DMFC can be PtRu but a PtRuP is much preferred for the anode catalyst. The addition of P into PtRu reduces the size of the PtRu. The size reduction increases the specific surface area of the PtRu catalyst, which improves the catalytic activities for hydrogen and methanol oxidation reactions. Fuel cell performance is greatly improved by using a composite cathode catalyst and PtRuP anode catalyst.

The above and other objects, features and advantages of the present invention will become more fully understood from the detailed description given herein below and the accompanying drawings which are given by way of illustration only, and thus are not to be considered as limiting the present invention.

### BRIEF DESCRIPTION OF THE DRAWINGS

FIG. 1 is a schematic view of a composite catalyst according to the present invention;

FIG. 2 is a TEM images of Pt nanoparticles and dumbbell-shaped Pt—Fe₃O₄ nanoparticles of different size: (a) 3 nm Pt, (b) 5 nm Pt, (c) and (d) 3 nm-7 nm Pt—Fe₃O₄, (e) and (f) 3 nm-10 nm Pt—Fe₃O₄, (g) and (h) 5 nm-10 nm Pt—Fe₃O₄;

FIG. 3 is a HRTEM image of a dumbbell-shaped 3 nm-10 nm Pt—Fe₃O₄ nanoparticle showing the evidence of epitaxial growth;

FIG. 4 is XRD patterns of (a) 3 nm Pt. (b) 3 nm-7 nm Pt—Fe₃O₄, (c) 3 nm-10 nm Pt—Fe₃O₄ and (d) 5 nm-10 nm Pt—Fe₃O₄ nanoparticles;

FIG. 5 is an electron microscope image of a composite catalyst composed of Pt particles and Fe₃O₄ particles obtained in Example 1;

FIG. 6 is an electron microscope image of a composite catalyst composed of Pt particles and Fe₃O₄ particles obtained in Example 2;

FIG. 7 is an electron microscope image of PtRuP catalyst supported on a carbon black obtained in Example 3;

FIG. 8 is an electron microscope image of commercialized Pt catalyst supported on a carbon black obtained in Comparative Example 1;

FIG. 9 is a graph of the oxygen reduction activity obtained in Example 4 and Comparative Example 2;

FIG. 10 is a graph of the methanol oxidation activity obtained in Example 5 and Comparative Example 3; and

FIG. 11 is a schematic sectional view of a fuel cell obtained in Example 6;

FIG. 12 is a graph of the power density characteristics of PEFCs obtained in Examples 6 and 7 and Comparative Example 4.

### DESCRIPTION OF THE PREFERRED EMBODIMENTS

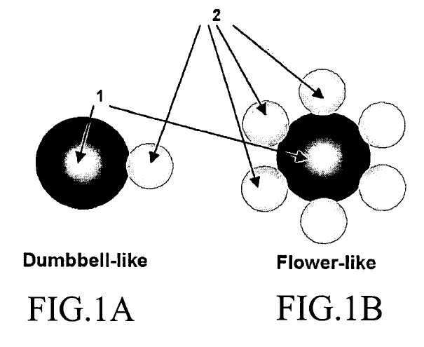

An oxygen electrode catalyst for a fuel cell of the present invention is a composite nanoparticle catalyst that is composed of a ferrite particle epitaxially grown on a noble metal particle as shown in FIG. 1. In FIG. 1, 1 representing a ferrite particle and 2 representing a noble metal particle. There are two types of shapes of the composite catalyst, i.e., one is a dumbbell-like composite catalyst (as depicted in the FIG. 1A) and the other is a flower-like composite catalyst (as depicted in FIG. 1B). The term “dumbbell-like” or “dumbbell-shaped” is discussed below. The term “flower-like” or “flower-shaped” means that a large ferrite particle has multiple smaller noble metal particles epitaxially conjugated to its surface.

In an embodiment, the particle size of the noble metal particle in the composite nanoparticle catalyst of the present invention is less than 10 nm. If the particle size is bigger than 10 nm, it does not have sufficient specific surface area to enhance the catalytic activity. The particle size of the ferrite particle in the composite catalyst of the present invention should be bigger than that of noble metal particle. If the particle size is smaller than that of noble metal, it becomes difficult to bond with multiple noble metal particles. A particle size from 5 to 50 nm is preferred for the ferrite particle.

The ferrite particle in the composite catalyst of the present invention is not limited so long as the ferrite has acid resistance. Ferrites having the following chemical formula of A²⁺B³⁺₂O₄, for A²⁺ are Mn²⁺, Fe²⁺, Co²⁺, Ni²⁺, Cu²⁺, Mg²⁺, Zn²³⁰ and Cd²⁺, for B³⁺ are Fe³⁺, Cr³⁺ and Mn³⁺, are preferable including mixtures thereof. Most preferably, the ferrite particle is Fe₃O₄.

The noble metal in the composite nanoparticle catalyst of the present invention is not limited to Pt. At least one of Au, Pd and Ag can be used for the composite catalyst.

A process of making a dumbbell-shaped composite nanoparticle catalyst is described in U.S. Pregrant publication no. 2006/0053971, the complete disclosure of which is herein incorporated by reference In its entirety. However, these catalysts are used in biomedical applications and as such, all composite particles which include Fe₃O₄ particles as part of the composite particles, also include FeS particles which enhance bioactivity. These FeS particles are not considered to be part of the inventive composite particles.

As part of the present invention is a process of making the composite nanoparticle catalyst with nanoparticle seeds, wherein the composite nanoparticle catalyst is composed of a noble metal particle and a metal oxide particle where the metal oxide particle is epitaxially grown on a surface of the noble metal particle, said process comprising: combining an organic solvent, a surfactant, and a metal oxide precursor to form a mixture, adding to the mixture noble metal nanoparticles dispersed in an organic solvent as seeds, heating the solution to reflux, and precipitating composite nanoparticles from the mixture. Preferably, the process is performed under a substantially inert atmosphere (such as N₂, argon, etc.) and the mixture is refluxed to thermally decompose the metal oxide precursor, after which point the mixture is exposed to oxygen (or air) to ensure that the final metal oxide forms. Also, it is preferred to add a reducing agent to the organic solvent and the surfactant and heat the mixture before adding the metal oxide precursor. The method in which the precipitation of the nanoparticles is initiated is not particularly limited, but it is preferred to reduce the temperature.

The majority of the final precipitated nanoparticles are “dumbbell-like” in shape (sometimes referred to herein as “dumbbell-shaped”). This means that the nanoparticles are a composite of two smaller particulates (metal oxide particle and noble metal particle) epitaxially conjugated to one another, both of which are exposed to the outer surface of the composite nanoparticle. Preferably, the metal oxide particle is larger than the noble metal particle.

Another aspect of the present invention is a process of making the composite catalyst without nanoparticle seeds, wherein the composite catalyst is composed of a noble metal particle and a metal oxide particle where the metal oxide particle is epitaxially grown on a surface of a noble metal particle, said process comprising: combining an organic solvent, a surfactant and a reducing agent, adding a metal oxide precursor, adding a noble metal precursor, heating said mixture to reflux, and precipitating nanoparticles from the mixture. The majority of the final precipitated nanoparticles are “dumbbell-like” in shape. Preferably, the process is performed under a substantially inert atmosphere (such as N₂, argon, etc.) and the mixture is refluxed to thermally decompose the metal oxide precursor, after which point the mixture is exposed to oxygen (or air) to ensure that the final metal oxide forms. Also, it is. preferred to heat the mixture of the organic solvent, the surfactant and the reducing agent before adding the metal oxide precursor. The method in which the precipitation of the nanoparticles is initiated is not particularly limited, but it is preferred to reduce the temperature.

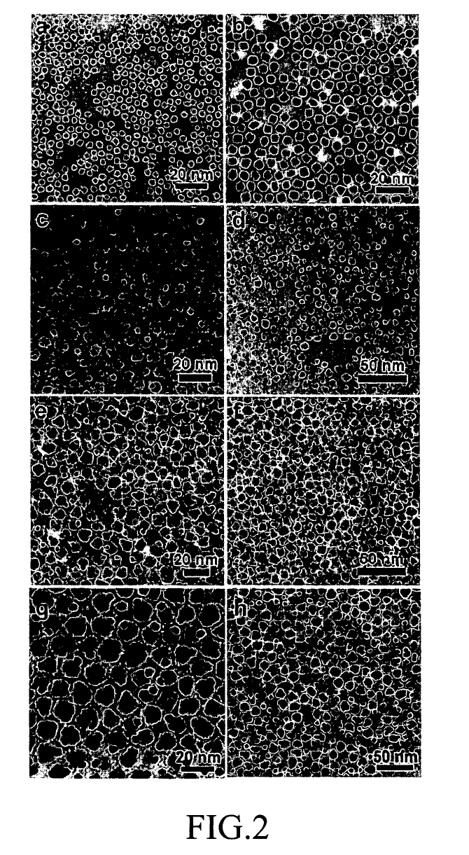

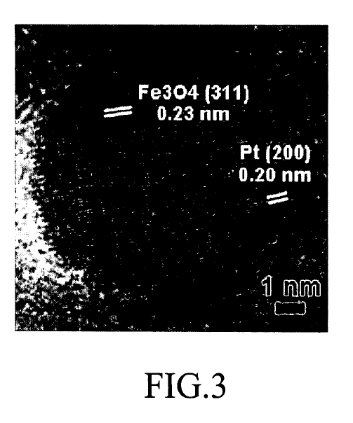

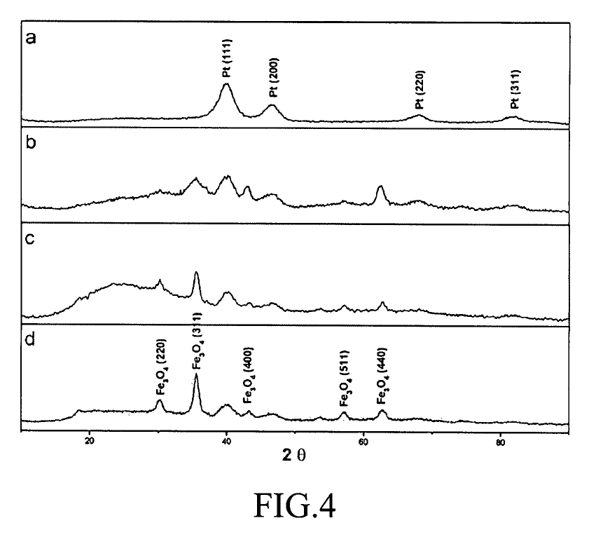

The present invention is also drawn to a process of preparing a noble metal nanoparticle with controlled size, said process comprising: mixing an organic solvent with a surfactant, adding a noble metal precursor to the mixture, heating said mixture, precipitating nanoparticles from said mixture. The noble metal nanoparticle is at least one selected from the group consisting of Pt, Pd, Au and Ag. FIG. 2a and 2b are TEM images of Pt nanoparticles of specific size. FIG. 4a is an XRD pattern of such Pt particles.

The organic solvent is not particularly limited by structure, so long as it serves its purpose of acting to effect reaction of the reactants. Preferably, the organic solvent is at least one selected from the group consisting of alkanes, alkenes, arenes, ethers, nitrites, ketones, chlorinated hydrocarbons and alkylamines. Most preferably, the organic solvent is at least one selected from the group consisting of octadecene, octadecane, 1,2,3,4-tetrahydronaphthalene, benzyl ether, diphenyl ether, oleylamine, trioctylamine, and dioctylamine.

The surfactant can be anionic, nonionic or amphoteric. Preferably, the surfactant is at least one selected from the group consisting of an amine having long carbon chains which are preferably C₆-C₂₀ in length (such as oleylamine, trioctylamine, and dioctylamine), fatty acids (such as oleic acid), tri-C₁-C₁₂-alkyl phosphines (such as trioctylphosphine), tri-C₁-C₁₂-alkyl phosphine oxides (such as trioctylphosphine oxide) and analogues thereof.

The metal oxide precursor is one which can act as a precursor for epitaxial growth of the oxide on a noble metal surface. Preferably, the metal oxide precursor is at least one selected from the group consisting of Fe(CO)₅, Co₂(CO)₈, Mn₂(CO)₁₀, Ni(CO)₈ and their analogues.

The noble metal precursor is either cationic or neutral and is at least one selected from the group consisting of Pt, Pd, Au and Ag.

The reducing agent is not particularly limited so long as it serves to reduce the noble metal salt. It is preferred that the reducing agent is at least one of tetradecanediol, and oleylamine.

The seeds which are used in the present process can be from any source, and can be made as described in Wang et al. (J. Am. Chem. Soc., 2007, 129, pp. 6974-6975), which is herein incorporated by reference in its entirety.

The dumbbell-like or flower-like composite nanoparticle catalyst is useful as a cathode catalyst for fuel cell.

The present invention, in part, is drawn to a method of reducing oxygen by exposing the acid resistant dumbbell-like or flower-like composite nanoparticle catalyst to oxygen.

The acid resistant dumbbell-like or flower-like composite nanoparticle catalyst is also useful as cathode catalyst for fuel cell.

Phosphorus containing compounds for synthesis of PtRuP catalyst for use in the anode include at least one of phosphorous acid, phosphate (including both the normal salt and acid salt), hypophosphorous acid, and hypophosphite. The preferred salt is an alkali metal salt such as sodium phosphite, sodium hydrogen phosphate and sodium hypophosphite, or ammonium salt such as ammonium phosphite, ammonium hydrogen phosphite and ammonium hypophosphite. Since a pentavalent P atom has the same electron configuration as Ne, it is chemically stable by the Octet Rule and does not serve as a P supply source. Therefore, phosphoric acid and phosphate having pentavalent P atom are preferably not used. The amount of the P containing compound is preferably within the range of 5 to 700% of the total moles of Pt and Ru in the synthetic solution. If it is less than 5%, the amount of P is less than 2 at. % and the effect of reducing size of a catalyst particle is not sufficient. If, on the other hand, it is more than 700%, the amount of P is higher than 50 at. % and the Pt and Ru components decrease to deteriorate catalyst activity. The method of forming the PtRuP catalyst can be any known in the art, such as that described in U.S. Pregrant publication no. 2005/0142428A1, which is incorporated herein by reference in its entirety.

### EXAMPLE 1

### Preparation of a Dumbbell-Like Composite Nanoparticle Catalyst Without Using Nanoparticle Seeds in the Synthesis

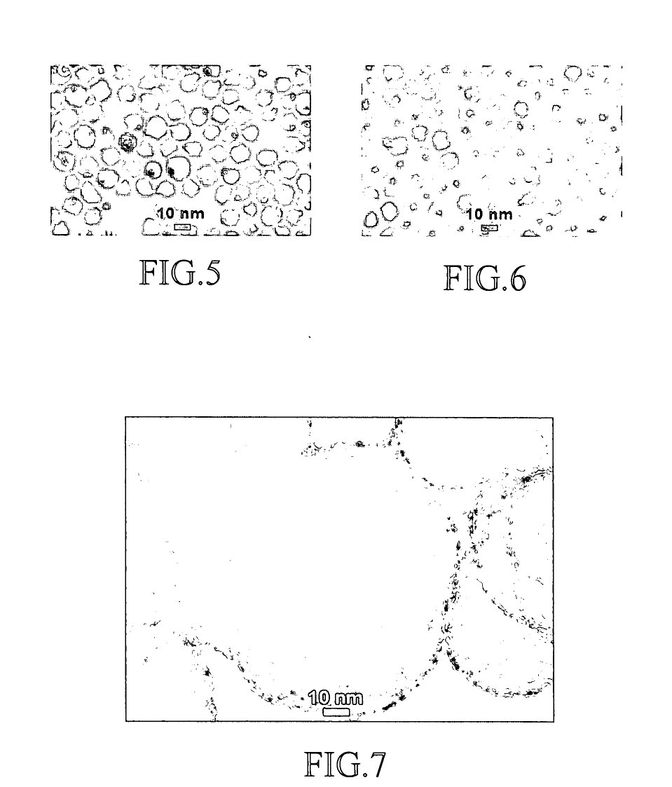

20 ml octadecene, 10 mmol (2.3 g) 1,2-tetradecanediol, 6 mmol (1.92 ml) oleic acid and 6 mmol oleylamine (2.04 ml) are mixed and degassed at 393 K under nitrogen flow for 30 min. 1 mmol (0.14 ml) Fe(CO)₅ is added into this hot solution. After 5 min, 0.5 ml oleylamine (70%, Aldrich) is added and a Pt precursor made by dissolving 0.1 mmol H₂PtCl₆.6H₂O (52 mg, Strem) in 5 ml octadecene in the presence of 0.5 ml oleylamine (70%, Aldrich) is injected into the solution at 393 K. The resulted solution is heated to reflux at 583 K and kept in reflux for 30 min. and then cooled down by removing the heating mantle. 50 ml absolute ethanol is added to precipitate the product, which is followed by centrifugation (6000 rpm, 10 min.). The precipitated nanoparticles are dispersed into hexane and washed by ethanol for another two times. The final product is dispersed in 15 ml hexane. A TEM image of the final product is in FIG. 5.

### EXAMPLE 2

### Preparation of a Dumbbell-Like Composite Nanoparticle Catalyst With Using Nanoparticle Seeds in the Synthesis

A mixture of 10 ml benzyl ether and 10 ml oleylamine is heated to 523 K under nitrogen flow. 0.2 ml trioctylphosphine is added to this hot solution, followed by 0.5 g Pt(acac)₂ dispersed in 2 ml benzyl ether and 2 ml oleylamine. The resulted solution is kept at 523 K for another hour and then cooled down by removing the heating mantle. 50 ml absolute ethanol is added to precipitate the product, which is followed by centrifugation (6000 rpm, 10 min.). The precipitated nanoparticles are dispersed into hexane and washed by ethanol for another two times. The final product is dispersed in 15 ml hexane. 20 ml octadecene and 1 ml oleic acid are mixed and degassed at 393 K under nitrogen flow for 30 min. 1 mmol (0.14 ml) Fe(CO)₅ is added under nitrogen blanket. After 10 min., 1 ml oleylamine is added and 20 mg Pt seeds (2 ml hexane dispersion, 10 mg/ml) is injected to this hot solution. The resulted solution is heated to reflux at 583 K and kept in reflux for 30 min. After reaction, the solution is cooled down by removing the heating mantle. 50 ml absolute ethanol is added to precipitate the product, which is followed by centrifugation (6000 rpm, 10 min.). The precipitated nanoparticles are dispersed into hexane and washed by ethanol for another two times. The final product is dispersed in 10 ml hexane. A TEM image of the final product is in FIG. 6.

### EXAMPLE 3

### Preparation of Anode Catalyst

1.69 mmol Pt(acac)₂, 1.69 mmol Ru(acac)₃ and 1.69 mmol NaPH₂O₂.H₂O were dissolved into 200 ml ethylene glycol. 200 ml ethylene glycol containing 0.5 g carbon black was added to the ethylene glycol solution. 0.05 mol/l sulfuric acid solution was dropped, and the pH value of the solution was adjusted to 3 by using a pH litmus paper. Under nitrogen gas atmosphere, the solution was, mechanically stirred and refluxed for 4 h at 473 K to deposit PtRuP catalyst on the carbon black. After the reaction ends, filtration, washing, and drying were performed. A TEM image of the final product is in FIG. 7.

### COMPARATIVE EXAMPLE 1

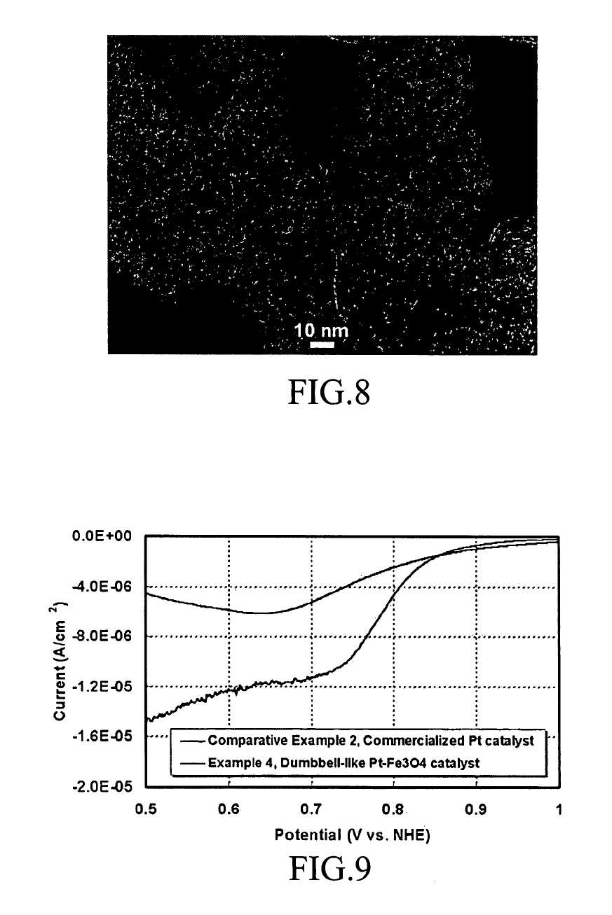

For oxygen reduction catalyst, commercialized Pt catalyst supported on carbon black was used. A TEM image of the particles is in FIG. 8.

Catalysts obtained in Example 1 to 3 and in, Comparative Example 1 were observed by transmission electron microscope (TEM) and the results are shown in FIGS. 5 to 8. In Example 1 (FIG. 5) and 2 (FIG. 6), it can be seen that dumbbell-like Pt—Fe₃O₄ composite catalysts are synthesized. In each TEM image, black parts are Pt particles and gray ones Fe₃O₄ particles. In these dumbbell-like composite catalysts, the size of Pt particles is about 3 nm and that of Fe₃O₄ is 10 to 15 nm. The size of PtRuP catalyst in Example 3 (FIG. 7) is 2 nm. The size of Pt catalyst in Comparative Example 1 (FIG. 8) is 3 nm. Composition of PtRuP catalyst in Example 3 was analyzed to be Pt₄₅Ru₄₄P₁₁ (at. %) by x-ray fluorescence spectroscopy.

### EXAMPLE 4

4 mg of dumbbell-like Pt—Fe₃O₄ catalyst in Example 1 was put between two carbon papers. The carbon papers were set in a Teflon holder having Au electric contacts. Using Ag/AgCl reference electrode and Au counter electrode, potential-current curve were taken in 1.5 mol/l sulfuric acid aqueous solution with potential sweep rate of 5 mV/s under oxygen gas bubbling at 308 K.

### COMPARATIVE EXAMPLE 2

The comparative example 2 measured potential-current curve in the same manner as Example 4 except for using the commercialized Pt catalyst in Comparative Examples 1.

The potential-current curves obtained in Example 4 and Comparative Example 2 are shown in FIG. 9. It is well known that oxygen is reduced on Pt catalyst and that the onset potential is around 0.85 V vs. NHE. In FIG. 9, the oxygen reduction current of dumbbell-like Pt—Fe₃O₄ composite catalyst and a commercialized Pt catalyst at potential of 0.75 V vs. NHE were compared for their respective oxygen reduction activities. The currents for dumbbell-like Pt—Fe₃O₄ composite catalyst and commercialized Pt catalyst are −9.5×10⁻² mA and −3.8×10⁻² mA, respectively. The current for the dumbbell-like Pt—Fe₃O₄ composite catalyst is about three times larger than that of the commercialized Pt catalyst, which indicates the composite catalyst in the present invention has higher oxygen reduction activity.

### EXAMPLE 5

4 mg of dumbbell-like Pt—Fe₃O₄ catalyst in Example 1 was put between two carbon papers. The carbon papers were set in Teflon holder having Au electric contacts. Using Ag/AgCl reference electrode and Au counter electrode, potential-current curve were taken in 1.5 mol/l sulfuric acid aqueous solution containing 20 vol. % of methanol with potential sweep rate of 5 mV/s under nitrogen gas bubbling at 308 K.

### COMPARATIVE EXAMPLE 3

The comparative example 3 measured potential-current curve in the same manner as Example 5 except for using the commercialized Pt catalyst in Comparative Examples 1.

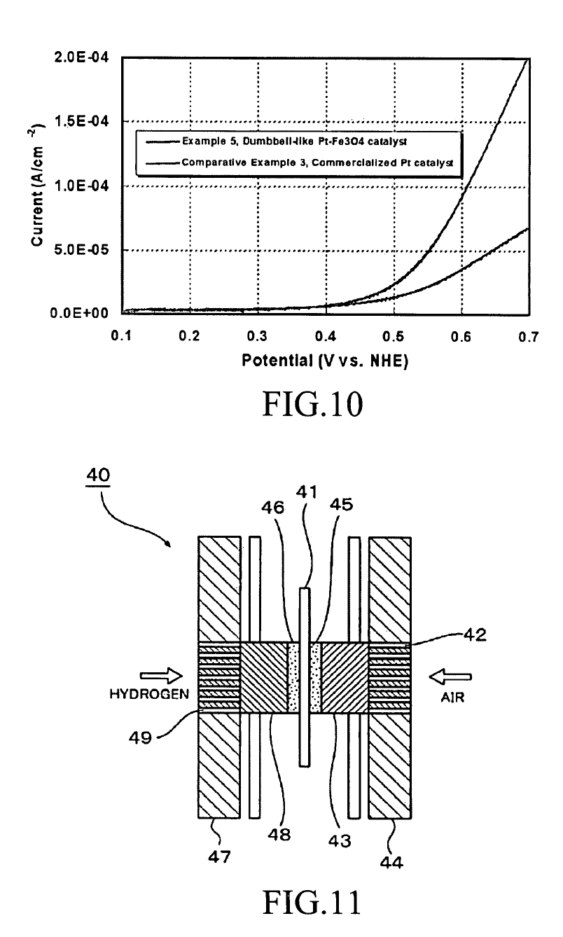

The potential-current curves obtained in Example 5 and Comparative Example 3 are shown in FIG. 10. It is well known that methanol is oxidized on Pt catalyst and that the onset potential is around 0.40 V vs. NHE. In FIG. 10, the methanol oxidation current of dumbbell-like Pt—Fe₃O₄ composite catalyst and a commercialized Pt catalyst at potential of 0.60 V vs. NHE were compared for their respective methanol oxidation activities. The currents for dumbbell-like Pt—Fe₃O₄ composite catalyst and commercialized Pt catalyst are 9.1×10⁻² mA and 3.5×10⁻² mA, respectively. The current for the dumbbell-like Pt—Fe₃O₄ composite catalyst is about three times larger than that of commercialized Pt catalyst, which indicates the composite catalyst in the present invention has higher methanol oxidation activity.

### EXAMPLE 6

An alcohol solution of pure water and Nafion®, available from E.I. DuPont de Namours and Company, was added to the Pt—Fe₃O₄ composite catalyst that is obtained in Example 1 and stirred, and then its viscosity was adjusted to create a catalyst ink. The catalyst ink was then applied onto a Teflon® sheet, available also from Dupont, in such a way that the application amount of the Pt—Fe₃O₄ composite catalyst was 0.5 mg/cm². After it dried, the Teflon® sheet was peeled off, thereby creating an oxygen electrode catalyst. Further, an alcohol solution of Nafion® and PtRu catalyst supported on carbon black (Purchased from Tanaka Noble Metal Ltd. having a mean diameter of the PtRu catalyst of 4 nm) were added and stirred, and then its viscosity was adjusted to create a catalyst ink. The catalyst ink was then applied onto a Teflon® sheet in such a way that the amount of the PtRu catalyst was 0.5 mg/cm². After it dried, the Teflon® sheet was peeled off, thereby creating a hydrogen electrode catalyst. Then, the Pt—Fe₃O₄ composite oxygen electrode catalyst and the PtRu hydrogen electrode catalyst were hot pressed to both sides of a polymer electrolyte membrane (Nafion® membrane 112, available from Dupont), thereby producing a membrane electrode assembly. Using the membrane electrode assembly and hydrogen gas as fuel, a polymer electrolyte fuel cell shown In FIG. 11 was produced. The polymer electrolyte fuel cell 40 of FIG. 11 includes an oxygen electrode side charge collector 44, an oxygen electrode side diffusion layer 43, a polymer electrolyte membrane 41, a hydrogen electrode side diffusion layer 48, a hydrogen electrode side charge collector 47, an air intake opening 42, an oxygen electrode Pt—Fe₃O₄ composite catalyst layer 45, a hydrogen electrode PtRu catalyst layer 46, and a hydrogen fuel intake opening 49. The oxygen electrode side charge collector 44 serves as a structure to take in the air (oxygen) through the air intake opening 42 and also as a power collector. The polymer electrolyte membrane 41 (Nafion® membrane 112, available from DuPont) serves as a carrier that carries protons generated in the hydrogen electrode to the oxygen electrode and also as a separator that prevents the short-circuit of the hydrogen electrode and the oxygen electrode. In the polymer electrolyte fuel cell 40 having this configuration, the hydrogen gas supplied from the hydrogen electrode side charge collector 47 passes through the hydrogen electrode side diffusion layer 48 and enters the hydrogen electrode catalyst layer 46 where it is oxidized into electrons and protons. The protons pass through the polymer electrolyte membrane 41 and move to the oxygen electrode side. In the oxygen electrode, the oxygen entering from the oxygen electrode side charge collector 44 is reduced by the electrons generated in the hydrogen electrode, and this oxygen and the protons react to generate water. The polymer electrolyte fuel cell 40 of FIG. 11 generates electric power by the hydrogen oxidation reaction and the oxygen reduction reaction.

### EXAMPLE 7

The example 7 produced a polymer electrolyte fuel cell in the same manner as Example 6 except for using the PtRuP catalyst produced in Example 3 instead of the PtRu catalyst as hydrogen electrode catalyst.

### COMPARATIVE EXAMPLE 4

The comparative example 4 produced a polymer electrolyte fuel cell in the same manner as Example 6 except for using the Pt catalyst produced in Comparative Example 1 instead of the Pt—Fe₃O₄ composite catalyst as the oxygen electrode catalyst.

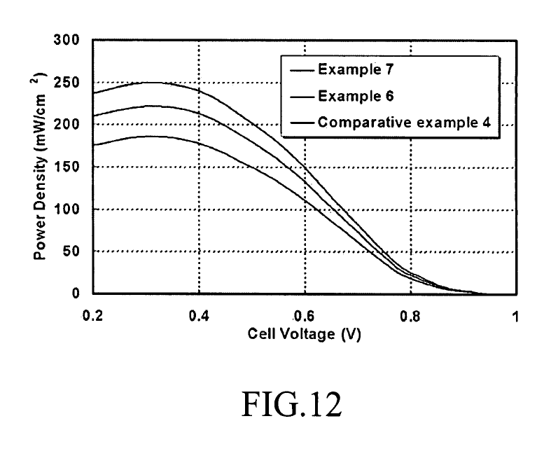

The power density characteristics of polymer electrolyte fuel cells obtained in Examples 6 and 7 and Comparative Example 4 are shown in FIG. 12. Since Example 6 used Pt—Fe₃O₄ composite catalyst having high oxygen reduction activity, the power density was improved compared with Comparative Example 4 using a commercialized Pt catalyst. In Example 7, the size of PtRuP anode catalyst obtained in Example 3 is 2 nm. In Example 6, the size of PtRu catalyst is 4 nm. This decrease in size of PtRuP anode catalyst further improved the power density.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A fuel cell comprising:
a fuel electrode;
an oxygen electrode; and
a polymer electrolyte membrane placed between the fuel electrode and the oxygen electrode,
wherein the oxygen electrode comprises an acid resistant composite catalyst comprising:
dumbbell-shaped composite nanoparticles each comprising a noble metal nanoparticle epitaxially conjugated to a ferrite particle, and/or
flower-shaped composite nanoparticles each comprising at least two noble metal nanoparticles epitaxially conjugated to one ferrite particles.

2. The fuel cell according to claim 1, wherein the noble metal particles have an average particle size of less than 10 nm.

3. The fuel cell according to claim 1, wherein the average particle size of the ferrite particles is bigger than the average particle size of the noble metal particles.

4. The fuel cell according to claim 1, wherein the ferrite particles have an average particle size of 5 to 50 nm.

5. The fuel cell according to claim 1, wherein the ferrite particles comprise at least one ferrite having the following formula:
A²⁺B³⁺₂O₄
wherein A²⁺ is selected from the group consisting of Mn²⁺, Fe²⁺, Co²⁺, Ni²⁺, Cu²⁺, Mg²⁺, Zn²⁺ and Cd²⁺; B³⁺ is selected from the group consisting of Fe³⁺, Cr³⁺ and Mn³⁺.

6. The fuel cell according to claim 1, wherein the noble metal particles comprise at least one of Pt, Au, Pd and Ag.

7. A membrane electrode assembly comprising:
a fuel electrode catalyst layer;
an oxygen electrode catalyst layer; and
a polymer electrolyte membrane placed between the fuel electrode catalyst layer and the oxygen electrode catalyst layer,
wherein the oxygen electrode catalyst layer comprises an acid resistant composite catalyst comprising:
dumbbell-shaped composite nanoparticles each comprising a noble metal nanoparticle epitaxially conjugated to a ferrite particle, and/or
flower-shaped composite nanoparticles each comprising at least two noble metal nanoparticles epitaxially conjugated to one ferrite particles.

8. The membrane electrode assembly according to claim 7, wherein the noble metal particles have an average particle size of less than 10 nm.

9. The membrane electrode assembly according to claim 7, wherein the average particle size of the ferrite particles is bigger than the average particle size of the noble metal particles.

10. The membrane electrode assembly according to claim 7, wherein the ferrite particles have an average particle size of 5 to 50 nm.

11. The membrane electrode assembly according to claim 7, wherein the ferrite particles contain at least one ferrite having the following formula:
A²⁺B³⁺₂O₄
wherein A²1 is selected from the group consisting of Mn²⁺, Fe²⁺, Co²⁺, Ni²⁺, Cu²⁺, Mg²⁺, Zn²⁺ and Cd²⁺; B³⁺ is selected from the group consisting of Fe³⁺, Cr³⁺ and Mn³⁺.

12. The membrane electrode assembly according to claim 7, wherein the noble metal particles comprise at least one of Pt, Au, Pd and Ag.

13. A process of preparing an acid resistant composite nanoparticle catalyst, wherein the composite nanoparticle catalyst is composed of a noble metal particle and a metal oxide particle epitaxially grown on a surface of the noble metal particle, said process comprising: mixing an organic solvent and a surfactant, adding a metal oxide precursor, adding noble metal nanoparticles dispersed in an organic solvent as seeds to form a mixture, heating the mixture to reflux, and precipitating composite nanoparticles from the mixture.

14. A process of preparing an acid resistant composite nanoparticle catalyst, wherein the composite nanoparticle catalyst Is composed of a noble metal particle and a metal oxide particle epitaxially grown on a surface of the noble metal particle, said process comprising: mixing an organic solvent with a surfactant and a reducing agent, adding a metal oxide precursor, adding a noble metal precursor to form a mixture, heating said mixture to reflux, and precipitating composite nanoparticles from the mixture.

15. The process according to claim 13, wherein the mixture is heated at reflux under a substantially inert atmosphere and the process further comprises a step of exposing thee mixture to oxygen.

16. The process according to claim 14, wherein the mixture is heated at reflux under a substantially inert atmosphere and the process further comprises a step of exposing the mixture to oxygen.

17. The process according to claim 15, wherein the noble metal nanoparticle is at least one selected from the group consisting of Pt, Pd, Au and Ag.

18. The process according to claim 13, wherein the noble metal precursor is reduced with a reducing agent and the metal oxide precursor is oxidized with oxygen.

19. The process according to claim 14, wherein the noble metal precursor is reduced with a reducing agent and the metal oxide precursor is oxidized with oxygen.

20. A method of reducing oxygen comprising exposing an acid resistant composite catalyst to oxygen,
wherein the acid resistant composite catalyst comprises:
dumbbell-shaped composite nanoparticles each comprising a noble metal nanoparticle epitaxially conjugated to a ferrite particle, and/or
flower-shaped composite nanoparticles each comprising a noble metal nanoparticle epitaxially conjugated to at least two ferrite particles.

21. The method of reducing oxygen according to claim 20, wherein the reduction of oxygen occurs in a membrane, electrode assembly or a fuel cell.
